(19) United States
(12) Patent Application Publication
(10) Pub. No.: US 2026/0061965 A1
(43) Pub. Date: Mar. 5, 2026

(54) SYSTEM FOR DETECTING SEATBELT ROUTING AND NOTIFYING OCCUPANTS OF IMPROPER SEATBELT ROUTING IN A VEHICLE

(71) Applicant: GM GLOBAL TECHNOLOGY OPERATIONS LLC, Detroit, MI (US)

(72) Inventors: David SPROULE, West Bloomfield, MI (US); Jaclyn Press SPROULE, West Bloomfield, MI (US); Brian BIGLER, Troy, MI (US); Ryan Aaron GELLNER, Livonia, MI (US); Tyler P. MORRIS, Madison Heights, MI (US)

(21) Appl. No.: 18/819,784

(22) Filed: Aug. 29, 2024

(51) Int. Cl. B60R 22/48

(52) U.S. Cl. CPC B60R 22/48; B60R 2022/485

(57) ABSTRACT

A system for detecting seatbelt routing includes an occupant classification module configured to determine physical attributes of an occupant in an occupant seat restrained by a seatbelt having a lap belt and a shoulder belt. A seatbelt routing quality module is configured to detect routing quality of the seatbelt based on shoulder belt position. A notification module is configured to notify the occupant of an improperly routed seatbelt, and an education module is configured to provide instructions to the occupant regarding how to adjust the seatbelt for proper seatbelt routing.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to occupant restraint systems for vehicles, more particularly, to a system for detecting seatbelt routing and notifying occupants of improper routing in a vehicle.

A three-point seatbelt includes a lap belt and a shoulder belt. Typically, one end of the lap belt is secured directly to a vehicle body structure, one end of the shoulder belt is secured to the vehicle body structure via a seatbelt retractor, and the lap and shoulder belts meet at the location of a tongue. To secure the occupant in a vehicle seat, the seatbelt is routed around the occupant, and the tongue is fastened in a seatbelt buckle. The seatbelt is routed properly when the lap belt extends across the waist of the occupant and the shoulder belt extends diagonally across the torso of the occupant and over the occupant's shoulder.

There are a number of ways in which a seatbelt may be routed improperly. For example, the lap belt may be routed underneath an occupant, and the shoulder belt may be routed on the wrong side of an occupant's head, under an occupant's arm, or outside of an occupant's arm. In another example, when an occupant is in a booster seat, the lap belt may be routed above hooked wings of the booster seat.

### SUMMARY

A system for detecting seatbelt routing, in accordance with the present disclosure, includes an occupant classification module configured to determine physical attributes of an occupant in an occupant seat restrained by a seatbelt having a lap belt and a shoulder belt. A seatbelt routing quality module is configured to detect routing quality of the seatbelt based on shoulder belt position. A notification module is configured to notify the occupant of an improperly routed seatbelt, and an education module is configured to provide instructions to the occupant regarding how to adjust the seatbelt for proper seatbelt routing.

In other features, a mass sensor is operatively connected to the occupant classification module, the occupant classification module being configured to classify the occupant based on sensed occupant mass.

In other features, the mass sensor comprises a pressure sensor operatively connected to a bladder built into an occupant seat supporting the occupant.

In other features, the bladder includes a pressure sensor and a bladder built into a seat base of the occupant seat.

In other features, a camera is operatively coupled to the occupant classification module, the occupant classification module being configured to classify the occupant based on physical attributes derived from images captured by the camera.

In other features, a seatbelt routing capture module is configured to detect actual routing of the seatbelt based on images captured by the camera.

In other features, the seatbelt routing quality module compares expected shoulder belt position for a classified occupant to actual routing of the shoulder belt to detect routing quality.

In other features, the education module is configured to present a set of text-based instructions for proper seatbelt routing to the occupant.

In other features, the education module is configured to present a video depicting how the seatbelt should be adjusted for proper seatbelt routing.

In other features, a belt adjustment module for automatically adjusting shoulder belt anchor height to establish proper seatbelt routing for the occupant.

A system for detecting seatbelt routing, in accordance with the present disclosure, includes an in-cabin sensor configured to detect an occupant in an occupant seat of a vehicle, an occupant classification module configured to determine physical attributes of the occupant, a seatbelt routing quality module configured to detect improper routing of the seatbelt on the occupant based on data from the occupant classification module, a notification module configured to notify the occupant of an improperly routed seatbelt, and an education module configured to provide instructions to the occupant regarding how the seatbelt can be adjusted for proper seatbelt routing.

In other features, the in-cabin sensor includes a mass sensor operatively connected to the occupant classification module, the occupant classification module being configured to generate an occupant classification based on sensed occupant mass.

In other features, the in-cabin sensor includes a camera operatively coupled to the occupant classification module, the occupant classification module being configured to evaluate images captures by the camera to determine physical attributes of the occupant and generate the occupant classification based on the physical attributes.

In other features, the classification module evaluates images captured by the camera to evaluate occupant position on the occupant seat to determine the physical attributes.

In other features, the classification module establishes an expected shoulder belt anchor height position based on occupant classification.

In other features, a seatbelt routing capture module configured to evaluate images captured by the camera to detect actual seatbelt routing on the occupant.

In other features, the seatbelt routing quality module is configured to detect improper routing of the seatbelt by comparing actual shoulder belt routing obtained from the seatbelt routing capture module with the expected shoulder belt anchor height position from the classification module.

In other features, the education module is configured to present, to the occupant, a set of text-based instructions for adjusting seat belt position for proper seatbelt routing.

In other features, the education module is configured to present a video to the occupant depicting how the seatbelt should be adjusted for proper seatbelt routing.

In other features, a belt adjustment module operatively connected to a linear actuator connected to a shoulder belt anchor, the belt adjustment module controlling the linear actuator to automatically set shoulder belt anchor height to achieve proper seatbelt routing on the occupant.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a vehicle including a system for detecting seatbelt routing and notifying occupants of improper routing in a vehicle, in accordance with the present disclosure;

FIG. 2 is a front view of an occupant seat and seatbelt system restraining including a properly routed shoulder belt on an occupant, in accordance with the present disclosure;

FIG. 3 is a front view of an occupant seat and seatbelt system restraining including an improperly routed shoulder belt riding too low on an occupant, in accordance with the present disclosure;

FIG. 4 is a front view of an occupant seat and seatbelt system restraining including an improperly routed shoulder belt riding too high on an occupant, in accordance with the present disclosure;

FIG. 5 is a block diagram illustrating a system for identifying improper shoulder belt routing in a vehicle, in accordance with the present disclosure; and

FIG. 6 is a flow diagram illustrating a method of identifying improper shoulder belt routing and providing feedback to an occupant regarding adjustment procedures that will result in proper routing, in accordance with the present disclosure.

In the drawings, reference numbers may be reused to identify similar and/or identical elements.

### DETAILED DESCRIPTION

Proper shoulder belt routing contributes to occupant comfort and seatbelt effectiveness. A shoulder belt that rides too high or too low on the shoulder may be uncomfortable. A shoulder belt that is uncomfortable may be routed in a manner that further reduces its effectiveness. Further, a shoulder belt that rides too high or too low on the shoulder may not be as effective as a shoulder belt that is properly routed. Many occupants do not understand how a shoulder belt should be properly routed in order to maximize comfort and effectiveness.

The present disclosure relates to a system that detects improper routing of the should belt and provides feedback to the occupant regarding how the seatbelt can be properly routed.

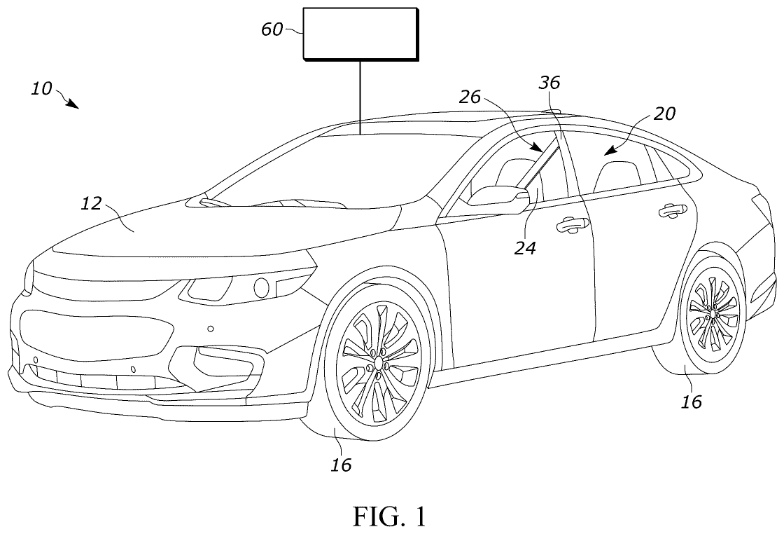

A vehicle, in accordance with the present disclosure, is indicated generally at 10 in FIG. 1. Vehicle 10 includes a body 12 supported by a plurality of wheels 16. Body 12 defines, in part, an occupant compartment 20 including occupant seats, one of which is indicated at 24. Each occupant seat 24 includes an associated seatbelt 26 that restrains an occupant in the event of a sudden change in acceleration forces on vehicle 10.

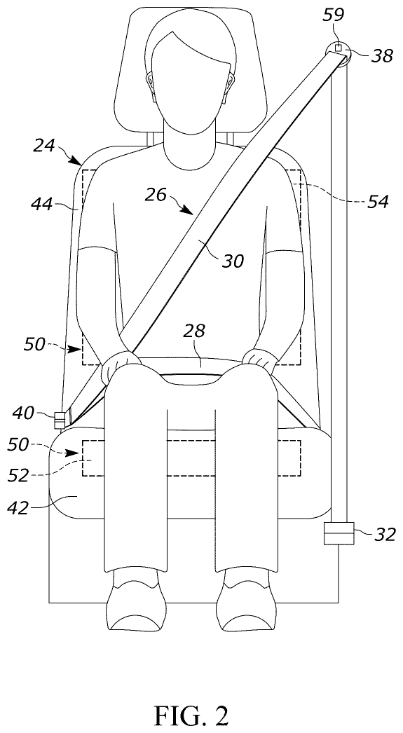

Referring to FIGS. 2, 3, and 4 and with continued reference to FIG. 1, seatbelt 26 includes a lap belt 28 and a shoulder belt 30. Seatbelt 26 includes a retractor mechanism 32 that is coupled to a B-pillar 36 (FIG. 1) in vehicle 10. B-pillar 36 also supports a shoulder belt anchor 38. Shoulder belt anchor 38 may be manually shifted along B-pillar 36 in order to change shoulder belt anchor height so as to accommodate occupants of various sizes. A lap belt anchor 40 is coupled to a floor (not shown) in occupant compartment 20. Occupant seat 24 includes a seat base 42 and a seat back 44 that support the occupant.

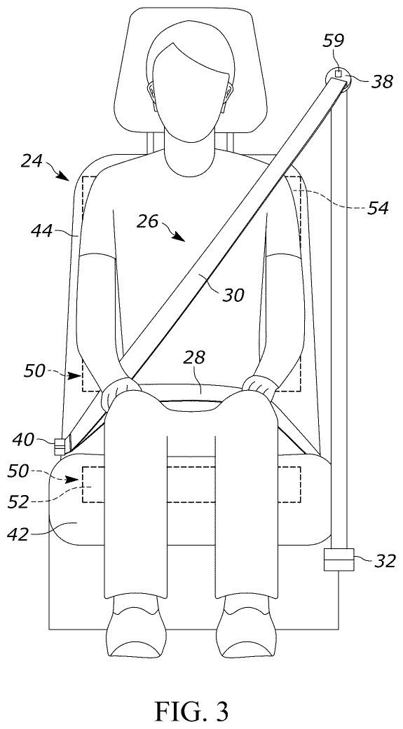

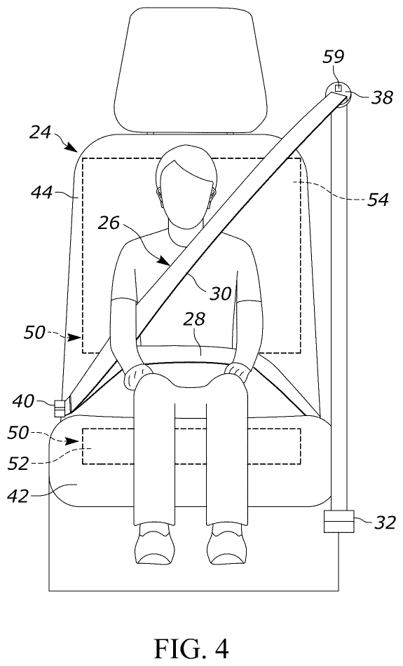

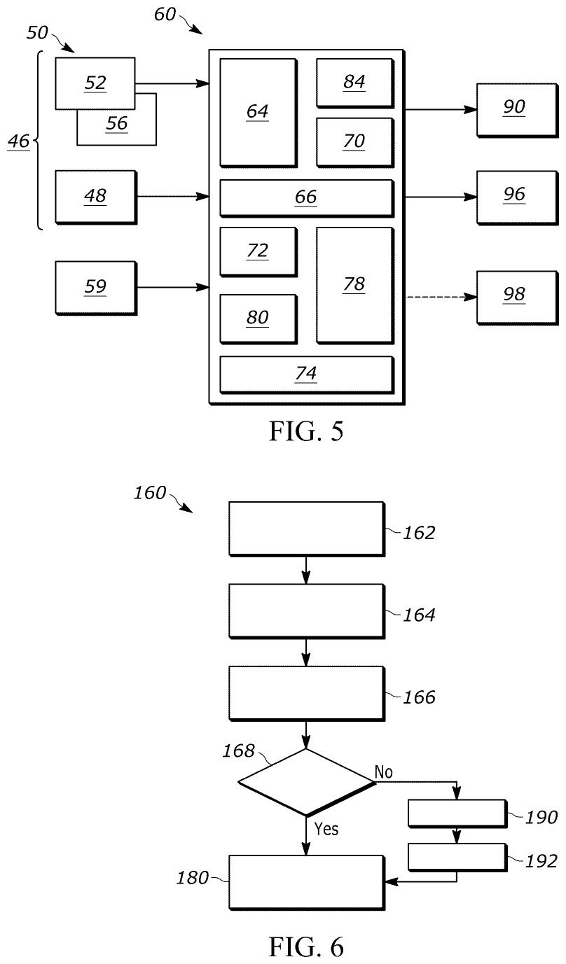

Referring to FIG. 5, in accordance with the present disclosure, vehicle 10 includes an in-cabin sensor system 46 that detects whether an occupant is present in occupant seat 24, and whether shoulder belt 30 properly routed. For example, in-cabin sensor system 46 can detect whether shoulder belt 30 is routed too low on an occupant such as shown in FIG. 3 or whether shoulder belt 30 is routed too high on the occupant such as shown in FIG. 4. In either case, instructions for properly routing shoulder belt 30 are provided to the occupant as will be detailed herein. In-cabin sensor system 46 also detects a position of seatbelt 26 on the occupant. In-cabin sensor system 46 includes a camera 48 and a mass sensor 50. Camera 48 is directed at occupant seat 24 while mass sensor 50 is integrated into seat base 42 and seat back 44.

In a non-limiting example, mass sensor 50 may include a first pressure sensor 52 connected in a first bladder 54 mounted in seat base 42 and a second pressure sensor 56 mounted in a second bladder 58 mounted in seat back 44. First pressure sensor 52 and second pressure sensor 56 output signals representative of pressure changes in first bladder 54 and second bladder 58 that are proportional to the mass of an occupant in occupant seat 24. In-cabin sensor system 46 may also include a position sensor 59 that detects a position of shoulder belt anchor 38 on B-pillar 36.

In accordance with the present disclosure, vehicle 10 includes a controller 60 for detecting seatbelt routing. Controller 60 is operatively connected with in-cabin sensor system 46. As shown in FIG. 5, controller 60 includes a central processing unit (CPU) 64, a non-volatile memory 66, an occupant classification module 70, a seatbelt routing capture module 72, a routing quality module 74, a notification module 78, and an education module 80. Occupant classification module 70 classifies the occupant in occupant seat 24 based on sensed mass from mass sensor 50 and images captured from camera 48.

The classification may include a population-based percentile. For example, occupant classification module 70 evaluates physical attributes or reference points on the occupant. The reference points may include mass, based on input from mass sensor 50, base of neck location, shoulder position, along with other physical attributes including occupant height based on the occupant's position on occupant seat 24 derived from images captured by camera 48 to develop an occupant classification. The physical attributes may also include neck length and shoulder width both of which can be obtained from images captured by camera 48. For example, the images are processed by occupant classification module 70 and are evaluated to determine where, for example, the shoulder of the occupant lies in relation to occupant seat 24, neck length, shoulder width, and the like.

The occupant may be classified as a 95% male if the occupant is larger than 95% of males in the population, a 50% male if the occupant is larger than 50% of males in the population, a 5% male if the occupant falls within 5% of the population. The occupant classification may also include percentages of the female population and percentages of the child population. The occupant classification is then used by occupant classification module 70 to establish an expected shoulder belt routing and an expected shoulder belt anchor position associated with the classification of the occupant. Controller 60 then determines baseline position limits for shoulder belt 30 based on the reference points determined by occupant classification module 70. The baseline position limits establish the expected shoulder belt anchor height.

The expected shoulder belt anchor height defines a height of shoulder belt anchor 38 that would likely result in proper shoulder belt routing for an occupant having the particular classification of the occupant. For example, a 95% male would expect shoulder belt anchor 38 to be at a height “x” while a 50% male would expect shoulder belt anchor to have a height “y’ that is less than “x” for shoulder belt 30 to be properly routed. Proper shoulder belt routing is defined as a state in which shoulder belt 30 is centered on the shoulder of the occupant such as shown in FIG. 2.

Routing capture module 72 evaluates the images captured by camera 48 to determine actual shoulder belt location on the occupant. For example, routing capture module 72 will first process the images captured by camera 48 to evaluate whether shoulder belt 30 is visible. If shoulder belt is not visible, e.g., is hidden behind the occupant, or if shoulder belt 30 is not routed over the shoulder of the occupant, a negative routing signal is output to notification module 78 which provides an alert to the occupant. If shoulder belt 30 is visible, then routing capture module 72 passes shoulder belt images to routing quality module 74 which compares actual shoulder belt position with expected the shoulder belt anchor position.

Routing quality module 74 determines routing quality by comparing actual shoulder belt position data, such as shoulder belt angle, distance from the occupant's neck, location of the shoulder belt on the occupant's shoulder, from routing capture module 72 and shoulder belt anchor position data from position sensor 56 with the expected shoulder belt routing and shoulder belt anchor position from occupant classification module 70. Routing quality module 74 evaluates whether the shoulder belt is in the proper position for the particular occupant size. If shoulder belt 30 is properly positioned, e.g., shoulder belt 30 extends across the occupant within the calculated position limits, routing quality module 74 will output a positive routing signal. If, however, shoulder belt 30 is outside of the calculated position limits, e.g., is too close to the occupant's neck (FIG. 3) or is falling off the shoulder (FIG. 4), routing quality module 72 will output a negative routing signal.

If routing quality module 72 outputs a positive routing signal, notification module 78 simply provides a notification to the occupant that shoulder belt 30 is properly routed. If, on the other hand, routing quality module 72 outputs a negative routing signal, notification module 78 will provide a notification to the occupant that shoulder belt 30 may benefit from adjustment and education module 80 provides instruction to the occupant describing how shoulder belt 30 may be adjusted for proper routing. For example, if shoulder belt 30 is too close to the occupant's neck, the occupant is instructed to lower shoulder belt anchor 38. If shoulder belt 30 is too low on the occupant's shoulder, the occupant is instructed to raise shoulder belt anchor 38.

The instruction may be in the form of voice prompts provided over vehicle speakers 90, text presented on a display portion (not separately labeled) of an infotainment system 96 or instructional videos that are presented on the infotainment system 96. Controller 60 is further shown to include an adjustment module 84 that, if provided, controls a linear actuator 98 coupled to shoulder belt anchor 38 to adjust shoulder belt position.

Reference will now follow to FIG. 6 in describing a method 160 of identifying improper shoulder belt routing and providing feedback to an occupant regarding adjustment procedures that will result in proper routing. In block 162, occupant details are captured by in-cabin sensor system 46. Camera 48 captures images of the occupant while mass sensor 50 determines occupant mass. Position sensor 56 detects a current position of shoulder belt anchor 38. In block 164, the occupant is classified based on sensed mass and images captured by camera 48. Occupant classification module 70 evaluates signals from first pressure sensor 52 and second pressure sensor 56 to determine occupant weight. Occupant classification module 70 also processes images captured by camara 48 to determine relative position of the occupant on, for example, seat back 44. Occupant classification module 70 further establishes baseline expectations for shoulder belt position based on the occupant's classification. The images from camera 48 processed by occupant classification module 70 are passed to routing capture module 72 to determine how shoulder belt 30 is routed.

In block 166, routing quality module 72 evaluates input from occupant classification module 70 and routing capture module 72 to determine how shoulder belt anchor 38 actually appears on the occupant. For example, routing quality module 72 evaluates the baseline expectations established by occupant classification module 70 to determine a proper shoulder belt anchor position for the occupant. In block 168, controller 60 evaluates whether the current or actual shoulder belt anchor position aligns with the proper shoulder belt anchor position set in the baseline by occupant classification module 70. If, in block 168, shoulder belt 30 is determined to be properly routed, Controller 60 provides a proper routing notification to the occupant in block 180.

If, on the other hand, in block 168 shoulder belt 30 is determined to be improperly routed, an improper routing notification is presented to the occupant in block 190. In addition to the improper routing notification, controller 60 will present adjustment suggestions to the occupant, in the form of voice suggestions, text suggestions, and/or video suggestions regarding how shoulder belt 30 may be adjusted, for example, by shifting shoulder belt anchor 38 along B-pillar 36, for proper routing. If vehicle is so equipped, in block 192, controller 60 may through adjustment module 84, as authorized by the occupant, automatically adjust a position of the shoulder belt anchor 38 on B-pillar 36 to achieve proper shoulder belt positioning.

At this point, it should be understood that the examples set forth in the present disclosure describe a system that not only detects improper routing of a shoulder belt but also provides suggestions tailors to the specific occupant regarding how the shoulder belt may be properly routed. The suggestions may come in one or more forms including verbal instructions, text-based instructions, and/or instructional videos that may be presented on an onboard infotainment system. Further, if so equipped, the system may shift the shoulder belt anchor to a selected position to achieve proper shoulder belt routing tailored to a specific occupant. Further, the instructions may be based solely on occupant mass or images obtained through the camera and need not include the specific steps outlined herein.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5^{th} revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A system for detecting seatbelt routing comprising:
an occupant classification module configured to determine physical attributes of an occupant in an occupant seat restrained by a seatbelt having a lap belt and a shoulder belt;
a seatbelt routing quality module configured to detect routing quality of the seatbelt based on shoulder belt position;
a notification module configured to notify the occupant of an improperly routed seatbelt; and
an education module configured to provide instructions to the occupant regarding how to adjust the seatbelt for proper seatbelt routing.

2. The system according to claim 1, further comprising a mass sensor operatively connected to the occupant classification module, the occupant classification module being configured to classify the occupant based on sensed occupant mass.

3. The system according to claim 2, wherein the mass sensor comprises a pressure sensor operatively connected to a bladder built into an occupant seat supporting the occupant.

4. The system according to claim 3, wherein the bladder includes a pressure sensor and a bladder built into a seat base of the occupant seat.

5. The system according to claim 1, further comprising a camera operatively coupled to the occupant classification module, the occupant classification module being configured to classify the occupant based on physical attributes derived from images captured by the camera.

6. The system according to claim 5, further comprising a seatbelt routing capture module, configured to detect actual routing of the seatbelt based on images captured by the camera.

7. The system according to claim 6, wherein the seatbelt routing quality module compares expected shoulder belt position for a classified occupant to actual routing of the shoulder belt to detect routing quality.

8. The system according to claim 1, wherein the education module is configured to present a set of text-based instructions for proper seatbelt routing to the occupant.

9. The system according to claim 1, wherein the education module is configured to present a video depicting how the seatbelt should be adjusted for proper seatbelt routing.

10. The system according to claim 1, further comprising a belt adjustment module for automatically adjusting shoulder belt anchor height to establish proper seatbelt routing for the occupant.

11. A system for detecting seatbelt routing comprising:
an in-cabin sensor configured to detect an occupant in an occupant seat of a vehicle;
an occupant classification module configured to determine physical attributes of the occupant;
a seatbelt routing quality module configured to detect improper routing of the seatbelt on the occupant based on data from the occupant classification module;
a notification module configured to notify the occupant of an improperly routed seatbelt; and
an education module configured to provide instructions to the occupant regarding how the seatbelt can be adjusted for proper seatbelt routing.

12. The system according to claim 11, wherein the in-cabin sensor includes a mass sensor operatively connected to the occupant classification module, the occupant classification module being configured to generate an occupant classification based on sensed occupant mass.

13. The system according to claim 12, wherein the in-cabin sensor includes a camera operatively coupled to the occupant classification module, the occupant classification module being configured to evaluate images captures by the camera to determine physical attributes of the occupant and generate the occupant classification based on the physical attributes.

14. The system according to claim 13, wherein the classification module evaluates images captured by the camera to evaluate occupant position on the occupant seat to determine the physical attributes.

15. The system according to claim 14, wherein the classification module establishes an expected shoulder belt anchor height position based on occupant classification.

16. The system according to claim 15, further comprising: a seatbelt routing capture module configured to evaluate images captured by the camera to detect actual seatbelt routing on the occupant.

17. The system of claim 16, wherein the seatbelt routing quality module is configured to detect improper routing of the seatbelt by comparing actual shoulder belt routing obtained from the seatbelt routing capture module with the expected shoulder belt anchor height position from the classification module.

18. The system according to claim 11, wherein the education module is configured to present, to the occupant, a set of text-based instructions for adjusting seat belt position for proper seatbelt routing.

19. The system according to claim 11, wherein the education module is configured to present a video to the occupant depicting how the seatbelt should be adjusted for proper seatbelt routing.

20. The system according to claim 11, further comprising: a belt adjustment module operatively connected to a linear actuator connected to a shoulder belt anchor, the belt adjustment module controlling the linear actuator to automatically set shoulder belt anchor height to achieve proper seatbelt routing on the occupant.
